(19) United States
(12) Patent Application Publication
(10) Pub. No.: US 2005/0221073 A1
(43) Pub. Date: Oct. 6, 2005

(54) Elastomeric foam article

(76) Inventor: Der-Lin Liou, Taipei City (TW)

Correspondence Address: BIRCH STEWART KOLASCH & BIRCH, PO BOX 747, FALLS CHURCH, VA, 22040-0747, US

(21) Appl. No.: 10/815,786

(22) Filed: Apr. 2, 2004

(51) Int. Cl. B32B 3/26; B32B 3/00; B32B 9/00

(52) U.S. Cl. 428/304.4; 428/313.3; 428/318.4

(57) ABSTRACT

An elastomeric foam article such as a glove, or the like; which comprises at least one light weight foam structure layer having a density from about 0.07 g/cm³ to about 0.9 g/cm³, or adhere with one or more substrate material layer, and also relates to the processes and compositions for making such articles.

### FIELD OF THE INVENTION

This invention relates to an elastomeric foam article such as a glove, or the like; which is manufactured by dipping method, comprising at least one foam structure layer having a density from about 0.07 g/cm³ to about 0.9 g/cm³, and adhere with one or more substrate material layer. This invention also relates to processes and compositions for making such articles.

### BACKGROUND OF THE INVENTION

The conventional elastomeric article made by dipping method such as disposable glove, finger cot, household glove, swimming cap, condom, catheter, ureter, rain shoe, or the like, are rarely commercialized with a foam structures caused by the difficulties of getting the uniform foam structures with good physical and chemical performances.

In the traditional art, it is common to use chemical foaming agents or mechanism to blow up the polymeric material or mix with light weight hollow fillers in order to get the foam structure in the extrusion, calendering, blow/injection molding, or spraying processes, so as to make the foam articles such as sponge, woven or non-woven fabrics, carpet backing, cable, pillow, furniture parts and auto parts.

The chemical foaming agents such as toluenesulfony hydrazine and azobisisobutyronitrile, are normally functioned by creating a gas such as CO₂ or N₂, to blow up the polymeric material in order to get the foam structure. The mechanism method uses a high-speed agitator or blows the air into the polymeric material in order to create the foam structure. It is very difficult to control the homogenous foamed structures and deposit an evenly thickness foamed material onto a complicated shape mold under the dynamic situation in a dipping process such as when making the disposable glove, since the mold keep on rotating in order to deposit a evenly thin film. It need to consider a lot of factors such as surface tension, temperature, vapor pressure, gravity force, timing and etc., to maintain the foamed material in a stable condition, it is too complicate to produce a glove by this way.

Normally, the chemical foaming agent and mechanism method are applied in making simple sheet shape items by spraying, laminating or calendering the foamed polymeric material on a substrate such as woven/non-woven fabrics or paper or carpet. In the dipping process, a mold dips into polymeric material solution in order to get a film structure, the polymeric material is normally dispersing or emulsifying into a liquid solution form and then dry the solution to get the solid polymeric film.

When making the thin wall elastomeric articles such as condom, disposable glove, the polymeric material solution will keep at a low viscosity range in order to get a thin and evenly thickness coating layer on the mold. The light weigh hollow fillers such as hollow glass, hollow plastic fillers floating on the polymeric material solution due to the low density fillers is not able to be evenly distributed in the polymeric material solution. It is more reasonable to find a material which can be well distributed in the polymeric solution but will not interfere the dipping process of getting the uniform deposit layer on the mold and can be curing and foaming the polymeric material simultaneously.

In U.S. Pat. No. 4,737,407, Wycech disclosed a method of mixing a low viscosity thermoset resin and thermally expandable microspheres together to foam a continuous strand of paste-like uncured material. In U.S. Pat. No. 6,509,384 and U.S. Pat. No. 6,582,333, Kron et al., disclosed that a composition comprising one or more polymeric substances and thermally expandable microspheres to make foamed articles. In U.S. Pat. No. 6,593,381, Whinnery, Jr. disclosed a method utilizing a thermally expandable and expanded microspheres for providing an uniformly dense polymer foam body. The above prior arts related to applying the thermally expandable microspheres in making the articles by laminating, roller-coating, spraying, calendering, extrusion, blow/injection molding process in order to make articles such as textiles, paper, or woven and non-woven substrates, paint, tires, shoe soles and etc. However, there is no teaching of applying the thermally expandable microspheres in a dipping process and making the elastomeric article such as glove.

In U.S. Pat. No. 6,527,990, Yamashita et al., disclosed a method for producing a rubber glove, the glove has two or three layer films and the first layer film comprising a thermally expandable microspheres and/or Foaming agent in the coagulating synthetic rubber latex, so to improve the anti-blocking and grip properties. However, the thermally expandable microspheres are embodied limited at the outer layer surface but not in the main body or the inner layer/hand-contacting surface of glove. Furthermore, the method is restricted to apply on a waterbased polymeric system and the non-aqueous polymeric system such as polyvinyl chloride glove is not applicable by this method too.

In U.S. Pat. No. 5,138,719, Orlianges et al., disclosed that the glove or finger stall comprising acrylic resin microcapsules increased progressively 0% from the outer surface towards the inner surface to 90 to 95% to improve the slippery property.

In U.S. Pat. No. 5,395,666, Brindle disclosed that by coating a layer of elastomeric material comprising 4 to 20 microns silica particles on the glove to enhance the lubricity. In U.S. Pat. No. 6,016,570, Vande Pol et al., disclosed that the hand-contacting surface of the polyvinyl chloride glove is spray-coated by a plurality of raised droplets comprising polyurethane, acrylic resin, and derivatives so as to improve donning and to reduce tack. In U.S. Pat. No. 6,440,498, Schaller disclosed that a slip coating comprising a polymeric material and a raised, net-like rough structure on the hand-contacting surface of glove to improve the donning property. In U.S. Pat. No. 6,638,587, Wang et al., disclosed a coating layer comprising a silicone modified polyurethane and silicone resin particles on the hand-contacting surface of the glove, the rough surface eventually reduces coefficient of friction and increases lubricity. The above prior arts related to improving the lubricity of donning of powder-free disposable glove by coating or spraying a lubricity polymer or by comprising a particles or a designed special mold to create a rough hand-contacting surface on the glove, however, none of the above prior arts use the dipping method of this present invention to create a rough hand-contacting surface of the glove in order to improve the donning property.

In U.S. Pat. No. 4,843,652, Kuwahara disclosed that a towel glove comprising a foam material between the first and second layer of terry cloth provides easy access for wiping perspiration. Although, the towel glove contains a foam material for absorb the perspiration also, but the glove structure, material, making method and function are different with the present invention.

In U.S. Pat. No. 6,662,377, Williams suggests a protective garment such as glove, socks and vest, comprising a three layers structure, the inside and outside layers are knitted fabrics and the intermediate layer is polyurethane film containing a activated carbon microspheres; each layer is made into a sheet and are bonded together by a heat-sensitive adhesive; and then using the platen press to cutting out and then weld the boundary of the article shape, in order to provide the protection to the user against exposure to chemical vapors and hazardous agents. Obviously, the article is not made by dipping method and does not comprise foam structure layer.

### SUMMARY OF THE INVENTION

Therefore the primary object of the invention is to provide an elastomeric foam article such as a glove, or the like; which is manufactured by dipping method. The elastomeric foam article of the present invention comprises at least one foam structure layer that is obtained by heating a polymeric material comprising a thermally expandable microspheres or foaming agent which create gas to blow up the material and foam a lot of balloon like structure.

The foam structure layer having a low density range from about 0.07 g/cm³ to about 0.9 g/cm³, depending on the thickness, composition and physical or chemical performances requirements and desired effect. The low density feature can save the material consumption and benefit the environment. For example, the disposable glove is utilized in medical field by laboratory workers and physicians to reduce the incidence of contact contaminants or in the food packing process to keep the food's cleanness and many other industries; there are billions pieces glove consumed everyday, most of them are disposed or burn out and not able to recycle after being used for only a short period; with this feature, it can save thousand tones of material and can reduce the wastage per day as well as decreasing the environmental pollution. Therefore, it is an object of the invention to produce an elastomeric foam article made by a dipping process in order to reduce the wastage of material and cut down the material cost.

The thermally expanded microspheres or foaming agent create a rough surface and many cavities of the polymeric material. An elastomeric foam article such as disposable glove; comprising the foam structure not only cut down the polymeric material consumption but also improve the donning and absorption of sweat. When utilize this invention to make the disposable glove, the foam structure layer having a rough surface at the inner side of the glove or the surface contacting the wearer's hand, and a waterproof elastomeric material layer at the outer side of the glove, the rough surface give better donning property by a reduction of contact areas between glove and the wearer's hand, which eventually reduce the friction of donning and the possibility of allergic reactions. Furthermore, the foam structure with many cavities acting as a sponge significantly improved the moisture or perspiration absorption capability.

Other elastomeric articles such as household glove, chemical resistant glove, rain shoe, waterproof socks, swimming cap and the like having a wall thickness from about 200 microns to about 3000 microns, providing the protection of wearer from water or hazard materials; although, the wall thickness, length, shape, material, physical/chemicals performances, or function maybe different, with the same structure matrix arrangement as the disposable glove; the waterproof elastomeric material layer at the outer surface and the foam structure layer at the inner human tissue-contacting surface of the elastomeric foam article, the above articles can be made by the same concept of the present invention. The above elastomeric articles after dipping, curing and foaming processes is carried by the publicly well known surface treatment such as depositing a fine powder; or raising a chlorine water; or coating a lubricating layer; or flocking a natural/synthetic fiber, to prevent from sticky and improve the donning.

It is also an object of the invention to provide a elastomeric article with a rough surface foam structure layer at the human tissue-contacting side of a article in order to provide better donning, and perspiration absorption properties. As a result of the low thermo-conductivity of the foam structure, the elastomeric foam article with the foam structure layer improves the thermoinsulation property. This feature is useful especially in applying in cold or hot working condition such as household or food processing glove which is usually contacted with hot or frozen foods. The same concept also can be applied in making footwear, handwear or headwear to keep the body's warmth under the low temperature environment or cold weather. The waterproof elastomeric material layer keep out the cold staff such as snow, moisture, and envelope the body heat; and the light weight foam structure layer insulate the human tissue to direct contact with the outside hot or cold atmosphere.

It is also an object of the invention to provide an elastomeric article with the foam structure layer to improve the thermoinsulation property. The working glove is a knitted natural or synthetic yarn fabrics such as cotton, wool, polyester, nylon and the combinations at the skin-contact side to provide comfort wear, which is partial or totally coated with at least one elastomeric material at the outside of glove provide the protection against hazard materials; and is utilized in agriculture, finishing, construction, chemical material handling and many other industries. Top-coating a foam structure layer on the elastomeric material to create a rough surface at palm area can improve the grip strength or foaming the elastomeric material comprising thermally expandable microspheres to improve the adhesion between fabrics and elastomeric material and reducing the weight by applying the present invention. With the same structure arrangement and manufacturing process of the invention, it can also be applied in footwear making such as socks.

It is also an object of the invention to provide a method of making the working glove or socks with a foam structure layer to improve the grip property.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a SEM photo of top view of Example 1 natural rubber disposable glove showing the rough surface of foam structure layer.

FIG. 2 is a SEM photo showing the foam structure and the binding condition of elastomeric foam layer between waterproof elastomeric layer under stretching condition, there is no peeling or separation

FIG. 3 is a SEM photo showing the rough surface foam structure polyurethane layer over-coated on the substrate acrylonitrile butadiene rubber layer.

FIG. 4 is the SEM photo of the cross section of natural rubber working glove showing the rough surface and the binding condition between the elastomeric layer and cotton knitted fabrics.

FIG. 5A is a drawing of the household glove of Example 10.

FIG. 5B is a simplified drawing of the household glove of FIG. 5A showing the multi-layer glove having the first chloride isoprene foam structure layer at the outer side covering the palm portion and the second natural rubber layer covering the forearm and the third acrylonitrile butadiene rubber foam structure layer at the inner-hand contact side.

FIG. 6A is a drawing of the waterproof socks of Example 7.

FIG. 6B is a simplified drawing of the structure arrangement of FIG. 6A having the first knitted material at the inner feet-contacting side and the second natural rubber layer over-coated with the first knitted material and the third natural foam structure layer at the outer of the feet sole area.

FIG. 7 is the flow chart of the dipping method of the present invention.

### DETAILED DESCRIPTION OF THE PREFERRED EMBODIMENTS

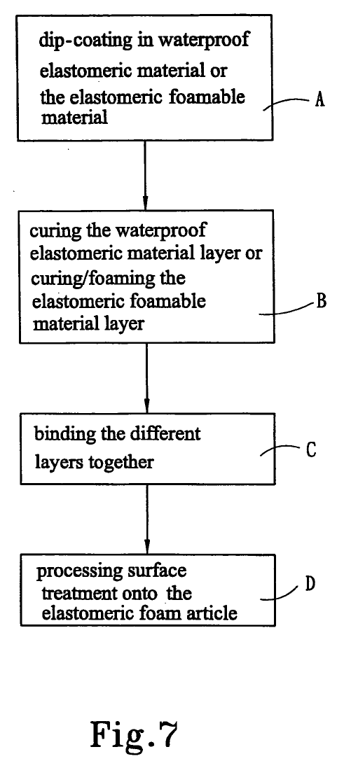

The invention related a elastomeric foam article made by dipping method including those adapted for use in partial or total cover or contact with human tissue, such as disposable glove, household glove, food processing glove, sponge glove, working glove, socks, thermoinsulation wears or the like, and the processes and compositions for making such articles. Please refer to FIG. 7, the dipping method comprises:
A. a desired shape mold with or without a natural/synthetic yarn knitted fabrics dip-coating in one or more solution comprising the waterproof elastomeric material or the elastomeric foamable material;
B. curing the waterproof elastomeric material layer or curing/foaming the elastomeric foamable material layer;
C. binding the different layers together; and
D. processing surface treatment onto the elastomeric foam article.

The elastomeric foam article comprising at least one foam structure layer, and adhere with one or more substrate material layers. The foam structure layer comprising a polymeric material and a thermally expanded microspheres or a foaming agent; and having a density from about 0.07 g/cm³ to about 0.9 g/cm³, more prefer from about 0.2 g/cm³ to about 0.7 g/cm³.

The substrate material is a natural/synthetic yarn knitted fabrics or an elastomeric material which is selected from the group consisting of natural rubber, synthetic rubber, polyurethane, polyacrylate, polybutylene, polyvinyl chloride, polyvinyl acetate, a block copolymer of styrene and butadiene and/or the mixed.

The elastomeric material is preferred but not limited to natural rubber, acrylonitrile butadiene rubber, chloroprene rubber, polyurethane, and polyvinyl chlorine. The polymeric material of the foam structure layer is selected from a group consisting of natural rubber, synthetic rubber, polyurethane, polyacrylate, polybutylene, polyvinyl chloride, polyethylene, polypropylene, polyvinyl acetate, a block copolymer of styrene and butadiene and/or the mixed, the polymeric material is preferred but not limited to natural rubber, acrylonitrile butadiene rubber, chloroprene rubber, polyurethane, polyvinyl chlorine, as long as the polymeric material of foam structure layer can bind well with the substrate material layer.

The foam structure layer is obtained by heating the thermally expandable microspheres, or a foaming agent, to foaming the polymeric material, and the thermally expandable microspheres or foaming agent is about from 0.5% to about 10% by weight of total solid content of the foam structure layer. The thermally expandable microspheres comprising a thermoplastic shell encapsulating a liquid hydrocarbon, when heat the liquid hydrocarbon which creating a gas inside the shell increases its pressure and the thermoplastic shell softens, result in a dramatic increasing the volume of the microspheres. The expanded microspheres diameter is from about 10 microns to about 200 microns. If the foam structure layer is at the inner human tissue-contact surface of the article is prefer the microspheres diameter range from about 10 microns to about 50 microns to get the better hand feel such as disposable glove. If the foam structure layer is at the outer surface of the article in order to improve the grip strength, thermo-insulation or reduce weight, the preferred microspheres diameter is range from about 50 microns to about 200 microns. The thermally expandable microspheres can be acted as a foaming agent and the expanding temperature is range from about 90° C. to about 200° C.; the prefer expanding temperature is range from about 90° C. to about 150° C. for applying in waterbased polymeric material solution such as natural rubber latex and from about 120° C. to about 200° C. for applying in non-aqueous polymeric material solution such as polyvinyl chloride emulsion. The thermally expandable microspheres are commercially available from the sources such as Expancel Inc., Duluth, Ga. and Soverign, Buffalo, N.Y.

There are several ways of gelling the elastomeric material and control the desired wall thickness onto the mold in dipping method. Namely, straight dipping, coagulant dipping, heatsensitive dipping, and the combinations. The straight dipping is the mold dip into an elastomeric material solution several times until get the desired thickness film. The coagulation dipping is the mold dip into a solution comprising a metal salt, such as calcium salt or a zinc salt, the calcium chloride and calcium nitrate are mostly common used; and then dip into the elastomeric material solution to gelling and get the desired thickness film, this method also can repeat the same process to get more thicker film onto the mold. The heatsensitive dipping is the elastomeric material solution comprising a heatsensitive agent or the elastomeric material itself is very sensitive to temperature such as polyvinyl chlorine, by heating the mold to above the heatsensitive temperature to gel the elastomeric material onto the mold. In the present invention, the above three gelling methods and the combinations will be applied according to the differences of materials, thickness, compositions and the features of the elastomeric article and other factors.

### EXAMPLES 1-3

Disposable Glove

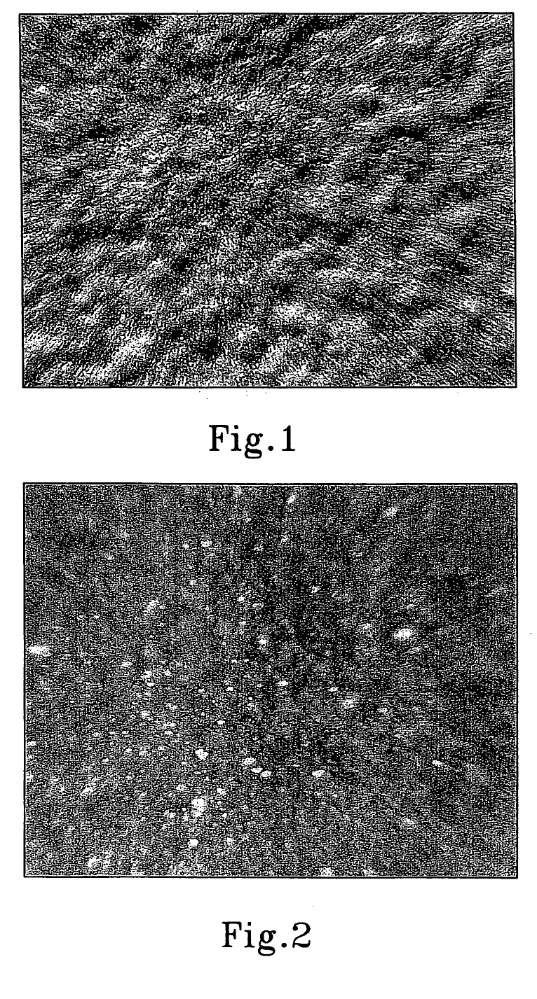

A ceramic glove mold is preheated to about 50° C.; and then dip into a coagulant agent solution at a temperature about 50° C.; and then pass through a oven at temperature about 90-140° C. for 1-3 minutes to dry the coagulant layer; and then dip into a elastomeric material solution at a temperature about 20-30° C. for about 5-15 seconds; and then dip into a elastomeric material solution comprising thermally expandable microspheres at a temperature about 20-30° C. for about 5-10 seconds to gel the desired thickness elastomeric material layer and the expandable elastomeric material layer onto the mold; and then pass through a oven at a temperature about 80° C. for about 30-60 seconds; and then dip into a water at a temperature of 50° C. for about 3-6 minutes to leach out the water soluble materials; and then pass through a oven at a temperature about 80-100° C. for about 5-10 minutes to evaporate the moisture of gelled elastomeric material and then increasing the oven temperature to about 125° C. to 145° C. for 5-10 minutes to cure and foam the elastomeric layer and bind the two layers together; and then dip into a 1% silicon solution; and then dry and cool for three minutes; and then strip and turn inside out the glove from the mold. The above example gloves stripping from the mold are easy and no difficulty of donning with damp and dry hand. The thermally expandable microspheres is selected from the expanded microspheres diameter range about 20-40 microns and expanding temperature from about 90° C. to about 150° C. The example of disposable glove compositions of the different elastomeric materials is showing in Table 1 and Table 2; and the Example 1 is a natural glove, Example 2 is a NBR glove, Example 3 is a polyurethane glove. Please also refer to FIG. 1 shows a SEM photo of top view of Example 1 natural rubber disposable glove showing the rough surface of foam structure layer.

TABLE 1

| Coagulant agent | Example 1 | Example 2 | Example 3 |
|---|---|---|---|
| solution ingredient | Dry or active parts by weight | | |
| Calcium nitrate | 5.0 | 12.0 | 12.0 |
| Wetting agent | 0.2 | 0.2 | 0.2 |
| Calcium carbonate | 3.0 | 3.0 | 3.0 |
| Water | 91.8 | 84.8 | 84.8 |

Wetting agent: a non-ionic surfactant Terric R.T.M. is available from ICI, U.K.

The first elastomeric material solution compositions are the same with Table 2, except without containing thermally expandable microspheres.

TABLE 2

| Second elastomeric material | Example 1 | Example 2 | Example 3 |
|---|---|---|---|
| solution ingredient | Dry or active parts by weight | | |
| Natural rubber latex | 100.0 | | |
| Acrylonitrile butadiene rubber | | 100.0 | |
| latex | | | |
| Polyurethane solution | | | 100.0 |
| Wetting agent | 1.0 | 1.0 | 0.5 |
| Stabilizer | 2.0 | 1.0 | 0.5 |
| Sulfur | 1.5 | 0.8 | |
| Zinc oxide | 1.0 | 1.5 | |
| Zinc diethyldithiocarbamate | 0.5 | 0.5 | |
| Zinc dibutyldithiocarbamate | 0.5 | | |
| Potassium hydroxide | 0.5 | 0.6 | |
| Titanium dioxide | 2.0 | 2.0 | 2.0 |
| Anti-foaming agent | 0.01 | 0.01 | 0.01 |
| Anti-aging agent | 2 | 1 | 1 |
| Dispersing agent | 0.2 | 0.2 | 0.1 |
| Thermally expandable | 5.0 | 5.0 | 5.0 |
| microspheres | | | |

### EXAMPLE 4

PVC Disposable Glove

For making the non-aqueous polymeric system such as polyvinyl chloride glove is as following:

A ceramic glove mold is preheated to temperature at about 70-80° C.; and then dip into a polyvinyl chloride solution for about 5-10 seconds; and then withdraw and drain to get the desired thickness layer on the mold; and then pass through a oven at temperature about 160-195° C. for 3 minutes; and then dip into polyvinyl chloride solution containing thermally expandable microspheres for about 3-8 seconds; and then withdraw and drain to the desired thickness layer; and then pass through a oven at temperature about 160-195° C. for 3-5 minutes to cure, foam and binding two layers together; and then cooled, strip and turn inside out the glove from the mold. The thermally expandable microspheres is selected from the expandable microspheres diameter about 40 microns and the expanding temperature range is about 110-200° C.

The first PVC layer solution composition is the same with Table 3, except without containing thermally expandable microspheres.

TABLE 3

| Second PVC solution ingredient | Dry or active parts by weight |
|---|---|
| PVC dispersion resin | 48 |
| Phthalate ester | 10 |
| Adipate ester | 38 |
| Epoxidized soybean oil | 1.5 |
| Polyethylene glycol | 0.5 |
| Thermally expandable | 5.0 |
| microspheres | |

The disposable glove made by the above making method, the first elastomeric material layer without containing the thermally expandable microspheres has a thickness about 50-80 microns, the second elastomeric foam structure layer containing thermally expandable microspheres has a thickness about 20-30 microns and expanding to 50-90 microns. The adhesion of two layers is good, it is not peeled or separated when stretched or pulled the glove, and the inner hand-contact surface of the glove having a matting, evenly rough surface. Please refer to FIG. 2, which shows a SEM photo showing the foam structure and the binding condition of elastomeric foam layer between waterproof elastomeric layer under stretching condition, there is no peeling or separation.

The glove density is about 0.7 g/cm³ and having the elongation at least 400% and tensile strength 12 Mpa at break, except the PVC glove having a elongation about 300% and tensile strength 8 Mpa.

For PVC disposable glove, it is not necessary to powdering or coating a lubricity polymer layer for improving the donning property in this invention. In the curing stage, the oil-based plasticizers evaporate and migrate to the surface and absorbed by the expanded microspheres result to a rough surface lubricity layer at the inner hand-contacting side of the glove. The stripping and donning is easy, this advantage provide an effective method to produce the PVC powder-free glove.

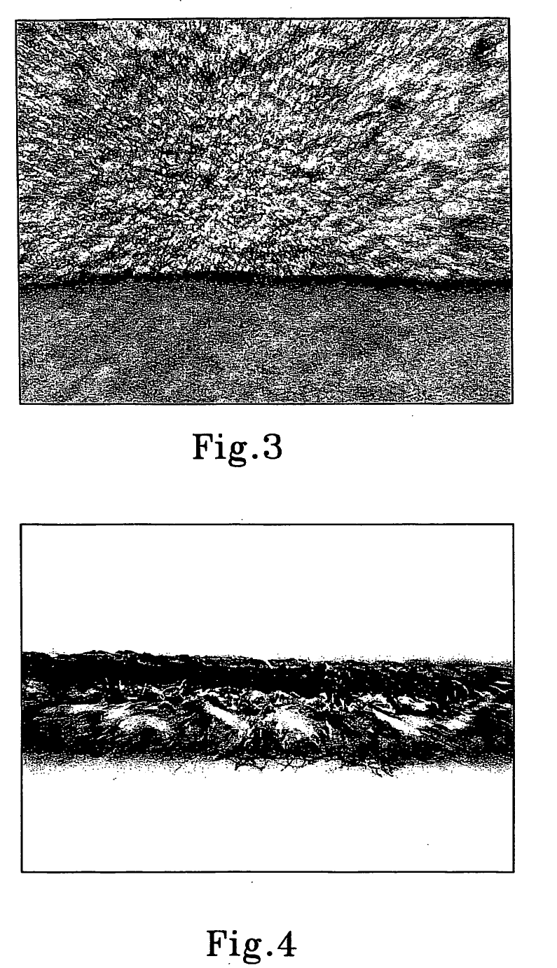

The above Examples 1-4 glove are using the same elastomeric material and compositions for the first elastomeric material layer and the second elastomeric foam structure layer, it is only for the easy illustration purpose of the invention; the different type of elastomeric materials and formulas are applicable, such as acrylonitrile butadiene rubber is the first elastomeric material layer and polyurethane containing thermally expandable microspheres is the second elastomeric foam structure layer, as long as having good adhesion between two layers. Please refer to FIG. 3 shows a SEM photo of the disposable glove in the invention having the rough surface foam structure polyurethane layer over-coated on the substrate acrylonitrate butadiene rubber layer.

The household glove or light duty general purpose glove are common utilized in food handling, cleaning and washing purpose; to provide the protection of wear from the light hazardous materials such as detergent, grease, oil and etc., having a wall thickness from about 200 microns to about 500 microns; the chemical resistant glove or the heavy duty glove is for handling chemical or toxic hazardous materials purpose, and having the wall thickness from about 400 microns to about 3000 microns. Both type of glove having the same structure arrangement, the major difference is the chemical glove having a thicker wall to resist the chemical penetration. The household glove or chemical resistant glove has various combinations of different material and structure depending on the desired effect.

### EXAMPLE 5

Household Glove

A ceramic glove mold is preheated to about 50° C.; and then dip into a coagulant agent solution up to the forearm about 32 cm depth at a temperature about 50° C.; and then pass through a oven at temperature about 90-140° C. for 1-3 minutes to dry the coagulant layer; and then dip into the first elastomeric material solution comprising thermally expandable microspheres up to the cuff about 20 cm depth at a temperature about 20-30° C. for about 5-10 seconds; and then dip into the second elastomeric material solution up to the forearm about 30 cm depth at a temperature about 20-30° C. for about 5-10 seconds; and then withdraw and pass through a oven at a temperature about 80° C. for 30 seconds; and then dip into the third elastomeric material solution comprising thermally expandable microspheres up to the forearm about 30 cm depth at a temperature about 20-30° C. for about 10-20 seconds onto the mold; and then pass through a oven at a temperature about 80° C. for about 30-60 seconds; and then dip into a water at a temperature 50° C. for about 3-6 minutes to leach out the water soluble materials; and then dip into a powder slurry containing 5% corn starch; and then pass through a oven at a temperature about 80-100° C. for about 5-10 minutes to evaporate the moisture of gelled elastomeric material and then increasing the oven temperature to about 125° C. to 145° C. for 10-15 minutes to cure and foam the elastomeric layer and bind the three layers together; and then strip and turn inside out the glove from the mold; and then carry chlorination treatment for making powder-free glove.

Instead of powdering treatment, the flocking process is carried after dipping the third elastomeric material layer; the mold having three elastomeric material layers and still in wet condition pass through a chamber in which the cotton fibers is spraying from the top of the chamber and using the statistic method to flock the fibers on the third elastomeric material layer, act as a binder; and then pass through a oven at a temperature about 80° C. for about 30-60 seconds; and then dip into a water at a temperature 50° C. for about 3-6 minutes to leach out the water soluble materials; and then pass through a oven at a temperature about 80-100° C. for about 5-10 minutes to evaporate the moisture of gelled elastomeric material and then increasing the oven temperature to about 125 to 145° C. for 10-15 minutes to cure and foam the elastomeric layer and bind the three layer and cotton fibers together; and then strip and turn inside out the glove from the mold. The thermally expandable microspheres of the first elastomeric material is selected from the expanded microspheres diameter range about 80-120 microns and expanding temperature from about 90° C. to about 150° C.; the thermally expandable microspheres of the third elastomeric material is selected from the expanded microspheres diameter range about 20-40 microns and expanding temperature from about 90° C. to about 150° C. The example household glove composition of the elastomeric material solution is showing in Table 4. The coagulant agent solution comprises 20% calcium nitrate, 0.3% wetting agent, and 3% calcium carbonate.

TABLE 4

| Elastomeric material solution | [A] | [B ] | [C] |
|---|---|---|---|
| ingredient | Dry or active parts by weight | | |
| Natural rubber latex | | 100.0 | |
| Acrylonitrile butadiene rubber | | | 100.0 |
| latex | | | |
| Chloride isoprene rubber latex | 100.0 | | |
| Wetting agent | 2.0 | 1.0 | 0.5 |
| Stabilizer | 2.0 | 1.0 | 0.5 |
| Sulfur | 1.5 | 0.8 | 0.8 |
| Zinc oxide | 4.0 | 1.5 | 1.0 |
| Zinc diethyldithiocarbamate | 1.0 | 0.5 | 0.5 |
| Zinc dibutyldithiocarbamate | 0.5 | 0.5 | 0.5 |
| Potassium hydroxide | 0.5 | 0.5 | 0.6 |
| Titanium dioxide | 2.0 | 2.0 | 2.0 |
| Anti-foaming agent | 0.02 | 0.01 | 0.01 |
| Anti-aging agent | 1.0 | 1.5 | 1.0 |
| Dispersing agent | 0.2 | 0.2 | 0.1 |
| Thermally expandable | 2.0 | | 5.0 |
| microspheres | | | |

In Table 4, [A] is the first elastomeric material solution, and [B] is the second elastomeric material solution, and [C] is the third elastomeric material solution. Chloride isoprene rubber latex is available from Neoprene. R.T.M. duPont, USA

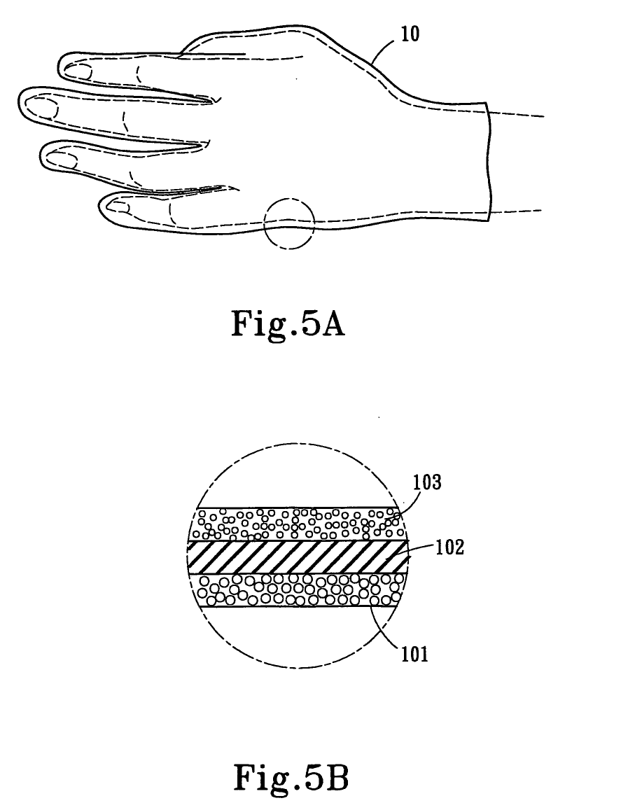

Please refer to FIGS. 5A and 5B, which show a drawing of the household glove of Example 5 and a simplified drawing of the household glove of FIG. 5A showing the multi-layer glove 10 having the first chloride isoprene foam structure layer 101 at the outer side covering the palm portion and the second natural rubber layer 102 covering the forearm and the third acrylonitrile butadiene rubber foam structure layer 103 at the inner-hand contact side.

The household glove 10 using three different elastomeric materials, each one has different feature of physical properties and chemicals resistant performances, such as the chloride isoprene rubber is soft and having good weather resistant ability, natural rubber layer 102 is comfortable to wear and having good alcohol resistant ability and the acryonitrile butadiene rubber having low modules and good grease resistant ability. As shown in FIG. 5B, the first chloride isoprene foam structure layer 101 comprises 80-120 microns expanded microspheres to improving the grip strength, and the third acrylonitrile butadiene rubber layer 103 comprised 20-40 microns expanded microspheres to improving the donning, perspiration absorption, and thermoinsulation. The multi-layer household glove is comfortable to wear and provide a good protection against various chemicals, and having a density about 0.85 g/cm³ with a wall thickness about 300 microns and the elongation 360% and tensile strength 22 Mpa at break.

The working glove have various types, Example 6 showing a glove having a cotton lining at the hand-contact side cover the forearm for comfortable wearing, and the first natural rubber layer is totally cover the substrate cotton glove to provide the forearm portion with fully protection against hazardous materials, and the second natural rubber foam structure layer with a rough surface cover the palm portion to provide a good grip strength.

### EXAMPLE 6

Working Glove

A 35 cm length stretchable cotton knitted glove put on a mold; and then dip into coagulant agent solution at a temperature about 50° C. for about 10-20 seconds; and then pass through a oven at temperature about 100° C. for 1-3 minutes; and then dip into the first elastomeric material solution about 33 cm depth at temperature about 20-30° C. for about 20-30 seconds; and then dip into the second elastomeric material solution comprising thermally expandable microspheres about 20 cm depth at temperature about 20-30° C. for about 10-20 seconds; and then pass through a oven at a temperature about 100-150° C. for about 15-30 minutes to cure, foam and bind the three layer material together; then strip the glove from the mold; and then cut off the top portion without coated elastomeric materials. To improve quality and duration, the glove after stripped from the mold was raised in the water for 30 to 60 minutes to leach out the watersoluble materials; and then put into dryer to dry.

The elastomeric material solution compositions of example working glove is showing in Table 5, and the coagulant agent solution comprises 25% calcium nitrate 0.2% wetting agent, and the thermally expandable microspheres is selected from the expanded microspheres diameter is range about 80-120 microns. Please refer to FIG. 4 which shows a SEM photo of the cross section of the example natural rubber working glove in the invention showing the rough surface and the binding condition between the natural rubber layer and cotton knitted fabrics.

TABLE 5

| Elastomeric material solution | | |
|---|---|---|
| ingredient | First layer | Second layer |
| Natural rubber latex | 100.0 | 100.0 |
| Stabilizer | 2.0 | 2.0 |
| Sulfur | 1.5 | 1.5 |
| Zinc oxide | 4.0 | 4.0 |
| Zinc diethyldithiocarbamate | 1.0 | 1.0 |
| Zinc dibutyldithiocarbamate | 1.0 | 1.0 |
| Potassium hydroxide | 0.5 | 0.5 |
| Titanium dioxide | 2.0 | 2.0 |
| Pigment | 0.2 | |
| Anti-foaming agent | 0.02 | 0.01 |
| Anti-aging agent | 1.0 | 1.0 |
| Dispersing agent | 0.2 | 0.2 |
| Thickening agent | 3.0 | 1.0 |
| Thermally expandable | | 1.0 |
| microspheres | | |

### EXAMPLE 7

Waterproof Socks

A waterproof socks is made by the similar method with Example 6 working glove: a commercial available cotton socks put on the a feet shape mold; and then dip into coagulant agent solution at a temperature about 50° C. for about 10-20 seconds; and then pass through a oven at temperature about 100° C. for 1-3 minutes; and then dip into the first elastomeric material solution down to the top edge of socks at temperature about 20-30° C. for about 20-30 seconds; and then dip and keep the foot sole portion face down in horizontal position into the second elastomeric material solution comprising thermally expandable microspheres about 3 cm depth at a temperature 20-30° C. for about 10-15 seconds; and then withdraw and upside down the mold; and then put into a oven at temperature about 100 to 150° C. for about 15-25 minutes to cure, foam and bind the three layer material together; and then strip the socks from the mold; and then the socks is raised in the water for 30 to 60 minutes to leach out the watersoluble materials; and then put into a dryer for drying.

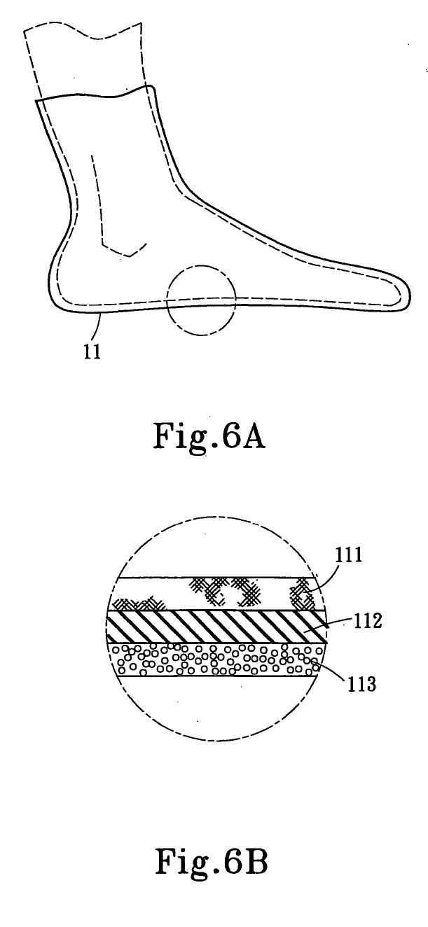

The compositions of example waterproof socks is the same with Example 6 working glove is showing in Table 5, and please refer to FIG. 6A and FIG. 6B, which is a drawing of the waterproof socks 11 of Example 7 and a simplified drawing of the structure arrangement of FIG. 6A having the first knitted material 111 at the inner feet-contacting side and the second natural rubber layer 112 over-coated with the first knitted material 111 and the third natural foam structure layer 113 at the outer of the feet sole area.

The first cotton knitted sock is for comfortable wearing and the second natural rubber layer 112 provide the protection against water even some hazardous materials and the third foam structure layer 113 on feet sole to improve the ground grip strength.

1. An elastomeric foam article which is manufactured by dipping method, comprising at least one foam structure layer, or adhere with one or more substrate material layer.

2. The elastomeric foam article according to claim 1, wherein the foam structure layer having a density from about 0.07 g/cm³ to about 0.9 g/cm³.

3. The elastomeric foam article according to claim 1, wherein the foam structure layer is obtained by heating elastomeric foamable material comprising thermally expandable microspheres to expand the volume of the elastomeric material.

4. The elastomeric foam article according to claim 3, wherein the elastomeric material is selected from the group consisting of natural rubber, synthetic rubber, polyurethane, polyacrylate, polybutylene, polyvinyl chloride, polyethylene, polypropylene, polyvinyl acetate, a block copolymer of styrene and butadiene or the mixed.

5. The elastomeric foam article according to claim 3, wherein the thermally expandable microspheres or foaming agent isis about from 0.5% to about 10% by weight of total solid content of the foam structure layer.

6. The elastomeric foam article according to claim 1, wherein the foam structure layer is obtained by heating elastomeric foamable material comprising foaming agent to expand the volume of the elastomeric material.

7. The elastomeric foam article according to claim 1, wherein the substrate material is a waterproof elastomeric material which is selected from the group consisting of natural rubber, synthetic rubber, polyurethane, polyacrylate, polybutylene, polyvinyl chloride, polyvinyl acetate, a block copolymer of styrene and butadiene or the mixed.

8. The elastomeric foam article according to claim 1, wherein the substrate material is selected from a group consisting of stretchable natural, synthetic and blended yarn knitted fabrics.

9. The elastomeric foam article according to claim 1, wherein the elastomeric foam article having a wall thickness from about 50 microns to about 300 microns; and comprising at least one foam structure layer adhere with at least one waterproof elastomeric material layer which at least one foam structure layer contacting with the mammalian tissue.

10. The elastomeric foam article according to claim 1, wherein the elastomeric foam article having a wall thickness from about 100 microns to about 3000 microns; and comprising at least two foam structure layers which at least one foam structure layer contacting with mammalian tissue and at least one waterproof elastomeric material layer in between the foam structure layers.

11. The elastomeric foam article according to claim 1, wherein the elastomeric foam article having a wall thickness from about 500 microns to about 3000 microns, comprising at least one foam structure layer adhere with a natural/synthetic yarn knitted fabrics which contacting with mammalian tissue, or at least one foam structure layer and one waterproof elastomeric material layer adhere with a natural/synthetic yarn knitted fabrics which contacting with mammalian tissue.

12. The elastomeric foam article which is manufactured by dipping method, wherein the dipping method comprising:
A. a desired shape mold with or without a natural/synthetic yarn knitted fabrics dip-coating in one or more solution comprising the waterproof elastomeric material or the elastomeric foamable material;
B. curing the waterproof elastomeric material layer or curing/foaming the elastomeric foamable material layer;
C. binding the different layers together; and
D. processing surface treatment onto the elastomeric foam article.

13. The elastomeric foam article according to claim 12, wherein the surface treatment comprises depositing a fine powder.

14. The elastomeric foam article according to claim 12, wherein the surface treatment comprises raising a chlorine water.

15. The elastomeric foam article according to claim 12, wherein the surface treatment comprises coating a lubricating layer.

16. The elastomeric foam article according to claim 12, wherein the surface treatment comprises flocking a natural/synthetic fiber.
